(19) United States
(12) Patent Application Publication
(10) Pub. No.: US 2010/0225605 A1
(43) Pub. Date: Sep. 9, 2010

(54) LIQUID CRYSTAL DISPLAY PANEL, LIQUID CRYSTAL DISPLAY APPARATUS AND CONTROL METHOD THEREOF

(75) Inventors: Chao-Chen WANG, Hsin-Chu (TW); Yao-Jen Hsieh, Hsin-Chu (TW); Heng-Sheng Chou, Hsin-Chu (TW); Pang-Chiang Chia, Hsin-Chu (TW); Yuet-Ping Lee, Hsin-Chu (TW); Che-Chia Hsu, Hsin-Chu (TW)

Correspondence Address: Portal IPR Services, P.O. Box 223205, Chantilly, VA, 20153, US

(73) Assignee: AU Optronics Corp.

(21) Appl. No.: 12/716,476

(22) Filed: Mar. 3, 2010

(30) Foreign Application Priority Data
Mar. 5, 2009 (TW) 098107099

(51) Int. Cl. G06F 3/041; G02F 1/1345

(52) U.S. Cl. 345/173; 349/149

(57) ABSTRACT

A LCD panel comprises a first substrate and the second substrate. The first substrate comprises a pixel, a sensor pad arranged adjacent to the pixel, a switch electrically coupled to the sensor pad, a pixel gate line electrically coupled to the pixel, a sensor gate line electrically coupled to the switch, and a readout line. The second substrate comprises a sensing device protruding form the second substrate, and a conducting layer covering on the sensing device and electrically coupled to a predetermined power. When assembling the second substrate with the first substrate, the sensing device is opposite to the sensor pad. When pressing the second substrate, the conducting layer covering on the sensing device contacts with the sensor pad. The sensor gate line controls on/off state of the switch to determine whether the sensor pad is electrically conducted with the readout line.

### CROSS-REFERENCE TO RELATED APPLICATIONS

This application is based upon and claims the benefit of priority from the prior Taiwan Patent Application No. 098107099, filed Mar. 5, 2009, the entire contents of which are incorporated herein by reference.

### BACKGROUND OF THE INVENTION

1. Field of the Invention

The present invention relates to the field of the liquid crystal display (LCD) technology, and more particularly to a LCD panel, a LCD apparatus and a control method with touch function.

2. Description of the Related Art

Since LCD apparatus has many advantages, such as high frame-quality, little size, light weight, and wide application-range, etc., the LCD apparatus is widely used into various consumer electronics, such as mobile phone, notebook computer, desktop display apparatus and television, etc. Thus the LCD apparatus has gradually substituted for conventional cathode ray tube (CRT) display apparatus to be a mainstream of display apparatuses.

Touch screen is a new human-computer interface and is more intuitive and more humanistic in use. Currently, many methods for integrating the touch screen directly with panel of the LCD apparatus are provided. Wherein, press-mode touch screen is not influenced by ambient light and is more humanistic and more intuitive in use, thus it has been paid more and more attention gradually. However, there is a problem of how to provide the touch screen with low cost, which has high touch detection function and is integrated into LCD panel.

### BRIEF SUMMARY OF THE INVENTION

The present invention relates to a liquid crystal display (LCD) panel with touch function.

The present invention also relates to a LCD apparatus.

The present invention still relates to a control method for LCD apparatus.

A LCD panel in accordance with an exemplary embodiment of the present invention is provided. The LCD panel comprises a first substrate and a second substrate. The first substrate comprises a first pixel, a first sensor pad, a first switch, a first pixel gate line, a first sensor gate line and a first readout line. The first sensor pad is arranged adjacent to the first pixel, the first switch is electrically coupled to the first sensor pad, the first pixel gate line is electrically coupled to the first pixel, and the first sensor gate line is electrically coupled to the first switch. The second substrate comprises a first sensing device and a conducting layer. The first sensing device protrudes from the second substrate, and the conducting layer covers on the first sensing device and is electrically coupled to a predetermined power. When assembling the second substrate with the first substrate, the first sensing device is opposite to the first sensor pad. When pressing the second substrate, the conducting layer covering on the first sensing device contacts with the first sensor pad. The first sensor gate line controls on/off state of the first switch to determine whether the first sensor pad is electrically conducted with the first readout line.

In an exemplary embodiment of the present invention, the first substrate further comprises a second pixel and a second sensor pad. The second sensor pad is arranged adjacent to the second pixel. The first sensor gate line controls the on/off state of the first switch to determine whether the second sensor pad is electrically conducted with the first readout line.

In an exemplary embodiment of the present invention, the first substrate further comprises a second readout line and a second switch. The second switch is electrically coupled to the first sensor gate line, and the first sensor gate line controls on/off state of the second switch. The second readout line is electrically coupled to the first readout line. Furthermore, the first substrate further comprises a third pixel, a third sensor pad, a third switch, a second pixel gate line and a second sensor gate line. The third sensor pad is arranged adjacent to the third pixel, the third switch is electrically coupled between the third sensor pad and the second readout line, the second pixel gate line is electrically coupled to the third pixel, and the second sensor gate line is electrically coupled to the third switch to control on/off state of the third switch. The second sensor gate line is electrically coupled to the first sensor gate line.

In an exemplary embodiment of the present invention, the first substrate further comprises a second readout line, a third pixel, a third sensor pad, a third switch, a second pixel gate line and a second sensor gate line. The third sensor pad is arranged adjacent to the third pixel, the third switch is electrically between the third sensor pad and the second readout line, the second pixel gate line is electrically coupled to the third pixel, and the second sensor gate line is electrically coupled to the third switch to control on/off state of the third switch. The second sensor gate line is electrically coupled to the first sensor gate line.

A LCD apparatus in accordance with another exemplary embodiment of the present invention is provided. The LCD apparatus comprises the LCD panel described in the above and a detection circuit. The detection circuit is electrically coupled to the first readout line (and the second readout line) to detect signals of the first readout line (and the second readout line).

A LCD apparatus in accordance with other exemplary embodiment of the present invention is provided. The LCD apparatus comprises a plurality of first pixels, a plurality of sensor pads, a plurality of readout lines, a plurality of switches, a plurality of pixel gate lines, a plurality of sensor gate lines and a gate-driving circuit. Each of the sensor pads is arranged adjacent to a corresponding one of the first pixels respectively, and the sensor pads generate different signals according to whether corresponding locations of the LCD apparatus are pressed. Each of the switches is arranged between the sensor pads and a corresponding one of the readout lines respectively. The pixel gate lines are electrically coupled to the first pixels to drive the first pixels. Each of the sensor gate lines is coupled to the corresponding switches respectively to control on/off states of the corresponding switches. The gate-driving circuit is for driving the pixel gate lines and the sensor gate lines. At least two of the readout lines are electrically coupled with each other, or at least two of the sensor gate lines are electrically coupled with each other.

In an exemplary embodiment of the present invention, at least two of the readout lines of the above LCD apparatus are electrically coupled with each other, and at least two of the sensor gate lines thereof are electrically coupled with each other.

In an exemplary embodiment of the present invention, the above LCD apparatus further comprises a detection circuit and a memory device. The detection circuit is electrically coupled to the readout lines to receive signals transmitted by the readout lines and convert the received signals to be a pressed data. The memory device is electrically coupled to the detection circuit to store the pressed data.

In an exemplary embodiment of the present invention, each of the sensor pads is arranged at an opaque area of a corresponding one of the first pixels.

In an exemplary embodiment of the present invention, each of the first pixels is surrounded by many other pixels of the LCD apparatus except for the first pixels.

A control method for LCD apparatus in accordance with other exemplary embodiment of the present invention is provided. The control method is adapted for the above LCD apparatus, and the control method comprises making each of the sensor gate lines and each of the pixel gate lines have a same enable time. Furthermore, the control method further comprises enabling at least two of the sensor gate lines simultaneously, and/or receiving signals transmitted by at least two of the readout lines simultaneously.

A control method in accordance with other exemplary embodiment of the present invention is adapted for a LCD apparatus. The LCD apparatus comprises a plurality of pixels, a plurality of sensor pads, a plurality of pixel gate lines and a plurality of sensor gate lines. The pixel gate lines are configured for driving the pixels, and the sensor gate lines are configured for driving the sensor pads. The sensor gate lines are not electrically coupled to the pixel gate lines, and an amount of the sensor gate lines is less than that of the pixel gate lines. The control method comprises: making each of the sensor gate lines and each of the pixel gate lines have a same enable time; and enabling at least one of the sensor gate lines simultaneously when enabling each of the pixel gate lines.

The exemplary embodiment of the present invention employs unique circuit constructions of the LCD panel and the LCD apparatus, such as the design of separating the pixel gate lines from the sensor gate lines, the special arrangement of the sensor pads, the designs of electrically coupling the many readout lines with each other, and/or electrically coupling the many sensor gate lines with each other, to obtain dense effective sensing areas for achieving a high touch detection capability with low cost.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a LCD apparatus with touch function in accordance with an exemplary embodiment of the present invention.

FIG. 2 is a partial cross-sectional view of the LCD panel of the exemplary embodiment of the present invention.

FIG. 3 is a partial cross-sectional view of the LCD panel as shown in FIG.2, when it is pressed by a finger.

FIG. 4 is a partial cross-sectional view of a LCD panel in accordance with another exemplary embodiment of the present invention.

FIG. 5 is a partial circuit diagram of a TFT array substrate of the exemplary embodiment of the present invention.

FIG. 6 is a partial circuit diagram of another TFT array substrate of the exemplary embodiment of the present invention.

FIG. 7 is a partial circuit diagram of other TFT array substrate of the exemplary embodiment of the present invention.

FIG. 8 is a partial circuit diagram of other TFT array substrate of the exemplary embodiment of the present invention.

### DETAILED DESCRIPTION

Reference will now be made to the drawings to describe exemplary embodiments of the present liquid crystal display (LCD) panel, the present LCD apparatus and the present control method thereof, in detail. The following description is given by way of example, and not limitation.

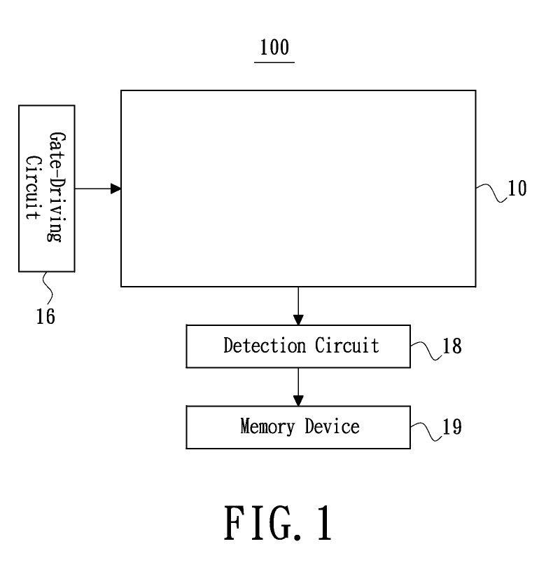

Refer to FIG. 1, which is a block diagram of a LCD apparatus 100 with touch function in accordance with an exemplary embodiment of the present invention. The LCD apparatus 100 includes a LCD panel 10, a gate-driving circuit 16, a detection circuit 18 and a memory device 19.

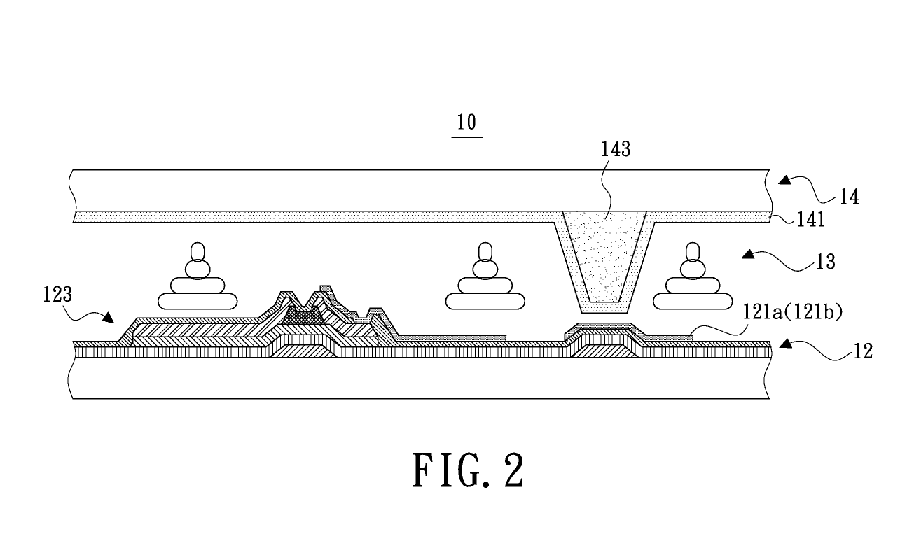

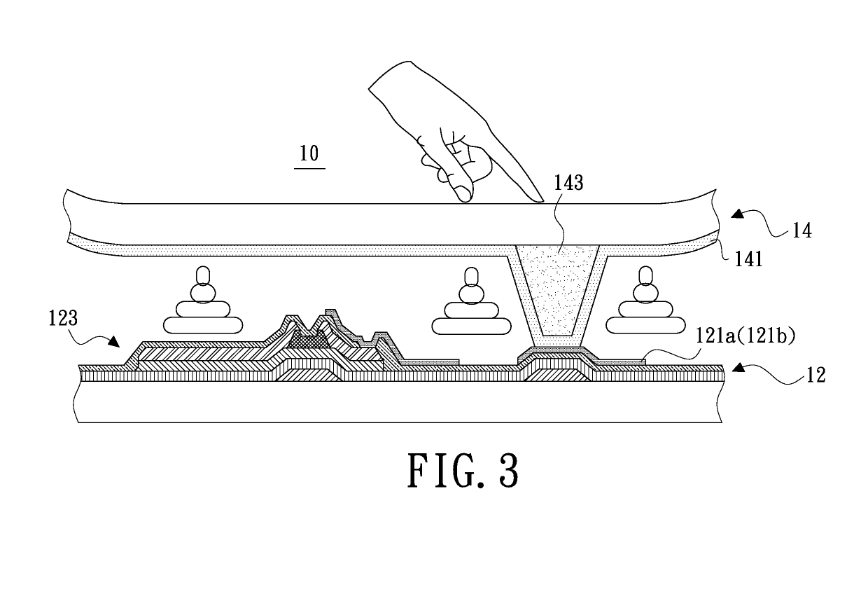

Refer to FIGS. 2 and 3, wherein FIG. 2 is a partial cross-sectional view of the LCD panel 10, and FIG. 3 is a partial cross-sectional view of the LCD panel 10 when it is pressed by an object such as a finger (not marked therein). The LCD panel 10 includes a thin-film transistor array (TFT array) substrate 12, a liquid crystal layer 13 and a second substrate 14 (such as a color filter substrate). The TFT array substrate 12 as shown in FIG. 2 includes a sensor pad 121a (121b) and a pixel 123, and the sensor pad 121a (121b) is arranged adjacent to the pixel 123 and in an opaque area of the pixel 123, such as a black matrix area. The second substrate 14 includes a sensing device 143 and a conducting layer 141 covering on the sensing device 143. The sensing device 143 protrudes from the second substrate 14, and the conducting layer 141 is electrically coupled to a predetermined power, such as a conventional common voltage Vcom of the LCD panel 10. When assembling the second substrate 14 with the TFT array substrate 12, the sensing device 143 is opposite to the corresponding sensor pad 121a (121b), and the liquid crystal layer 13 is sandwiched between the second substrate 14 and the TFT array substrate 12. As shown in FIG. 3, when the second substrate 14 is pressed by the finger, the conducting layer 141 covering on the sensing device 143 at a pressed location contacts with the corresponding sensor pad 121a (121b).

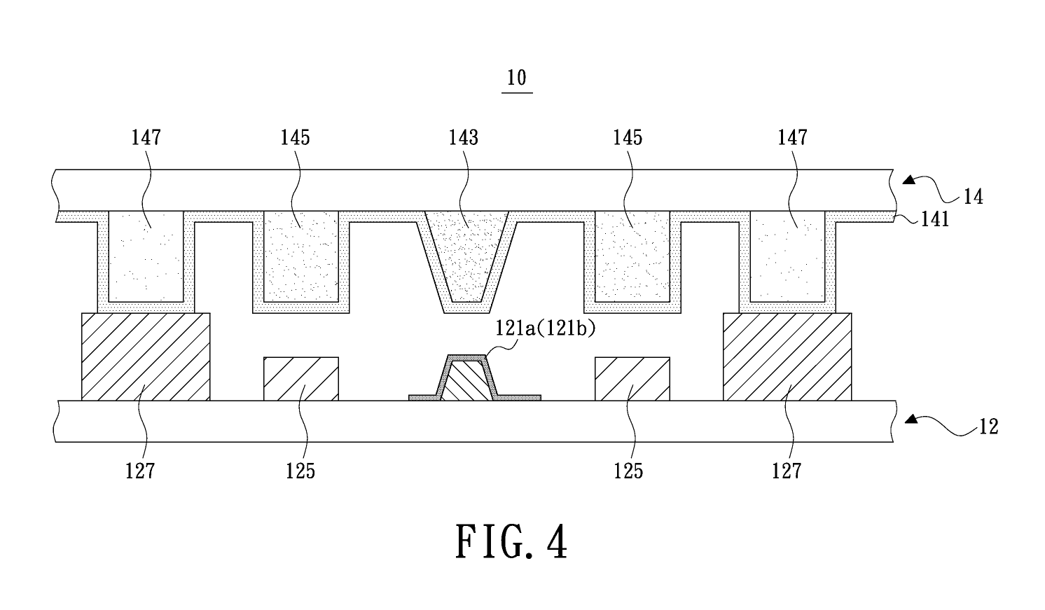

Furthermore, referring to FIG. 4, a plurality of insulating first bumps 125 and a plurality of insulating second bumps 127 further may be arranged on the TFT array substrate 12. Correspondingly, a plurality of first photo spacers 145 and a plurality of second photo spacers 147 are arranged on the second substrate 14. The first bumps 125 have a height different from that of the second bumps 127. The first photo spacers 145 and the second photo spacers 147 have a height approximately same to that of the sensing device 143, and are covered by the conducting layer 141. When assembling the second substrate 14 with the TFT array substrate 12, the first photo spacers 145 are opposite to the corresponding first bumps 125 respectively, and distances between the first photo spacers 145 and the corresponding first bumps 125 respectively are larger than a distance between the sensing device 143 and the sensor pad 121a (121b). The second photo spacers 147 are opposite to the corresponding second bumps 127 respectively, and distances between the second photo spacers 147 and the corresponding second bumps 127 respectively are approximately 0. Therefore, a gap between the second substrate 14 and the TFT array substrate 12 is maintained by the second photo spacers 147 and the second bumps 127. Furthermore, the first photo spacers 145 and the first bumps 125 are employed for preventing the LCD panel 10 from being damaged since the LCD panel 10 may bear an overlarge force to make a portion thereof overbend when being pressed.

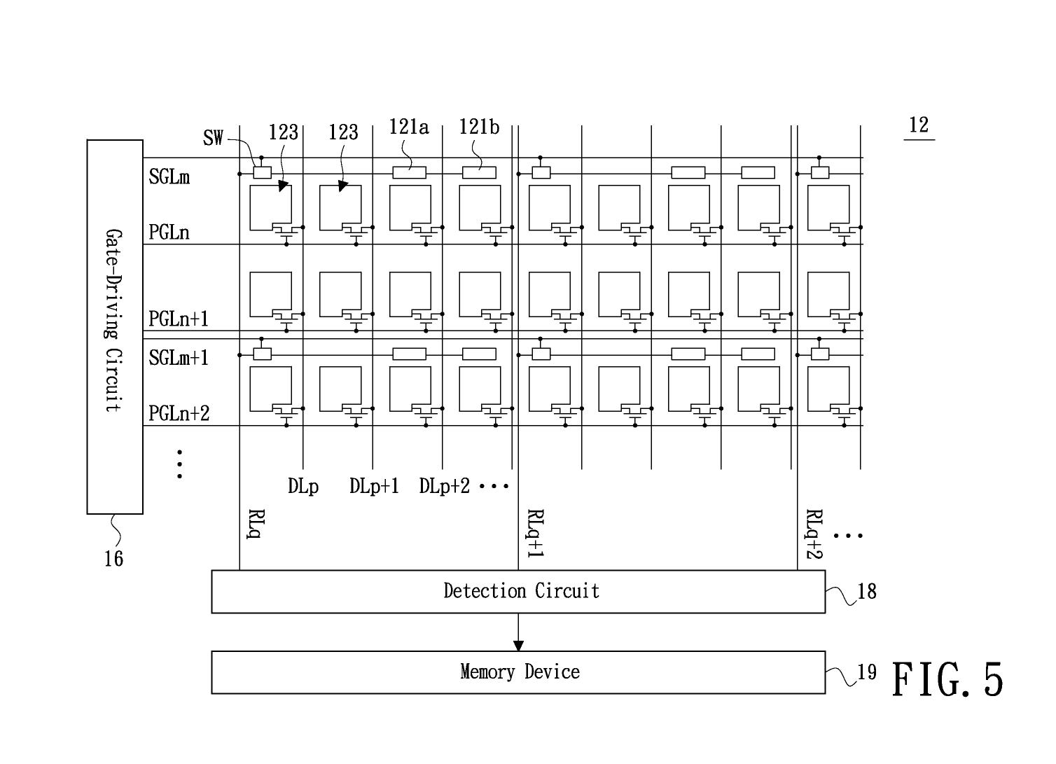

Refer to FIG. 5, which is a partial circuit diagram of the TFT array substrate 12 of the exemplary embodiment of the present invention. The gate-driving circuit 16, the detection circuit 18 and the memory device 19 of the LCD apparatus 100 are arranged on the TFT array substrate 12. As shown in FIG. 5, the TFT array substrate 12 includes a plurality of pixels 123, a plurality of pixel gate lines PGLn, PGLn+1, PGLn+2, a plurality of data lines DLp, DLp+1, DLp+2, a plurality of sensor pads 121a and 121b, a plurality of readout lines RLq, RLq+1, RLq+2, a plurality of switches SW and a plurality of sensor gate lines SGLm, SCLm+1. Each of the pixels 123 includes a thin-film transistor (not marked in FIG. 5) and a pixel electrode (not marked in FIG. 5) electrically coupled to a source electrode of the thin-film transistor. The pixel gate lines PGLn, PGLn+1, PGLn+2 are electrically coupled to gate electrodes of the thin-film transistors of the corresponding pixels 123 respectively to drive the pixels 123. The data lines DLp, DLp+1, DLp+2 are electrically coupled to drain electrodes of the thin-film transistors of the pixels 123 respectively to provide display data to the pixels 123. The sensor pads 121a and 121b are arranged adjacent to a corresponding one of the pixels 123 respectively, and generate different sensing signals according to whether corresponding locations of the LCD apparatus 100 are pressed. Herein, the adjacent two sensor pads 121a and 121b are electrically coupled with each other, and are electrically coupled with a corresponding one of the readout lines RLq, RLq+1, RLq+2 through a same switch. Each of the pixels 123 having the sensor pad 121a or 121b arranged adjacent thereto, is surrounded by many of the pixels 123 having no the sensor pads 121a and 121b arranged adjacent thereto, respectively. Each of the switches SW is arranged between the sensor pads 121a and 121b, and a corresponding one of the readout lines RLq, RLq+1, RLq+2 respectively. The sensor gate lines SCLm, SCLm+1 are electrically coupled to the corresponding switches SW to control on/off states of the corresponding switches for driving the corresponding sensor pads 121a and 121b.

In addition, the pixel gate lines PGLn, PGLn+1, PGLn+2 are electrically coupled to the gate-driving circuit 16 and are driven by the gate-driving circuit 16. The sensor gate lines SGLm, SGLm+1 are designed to be separated from (that is not electrically coupled to) the pixel gate lines PGLn, PGLn+1, PGLn+2, and an amount thereof is less than that of the pixel gate lines PGLn, PGLn+1, PGLn+2. The sensor gate lines SGLm, SGLm+1 are electrically coupled to various different signal-channels of the gate-driving circuit 16 and are driven by the gate-driving circuit 16. The readout lines RLq, RLq+1, RLq+2 are electrically coupled to various different signal-channels of the detection circuit 18 and transmit the sensing signals to the detection circuit 18. The received sensing signals are converted into pressed data (that is coordinates of pressed locations) by the detection circuit 18. The memory device 19 is electrically coupled to the detection circuit 18 to store the pressed data.

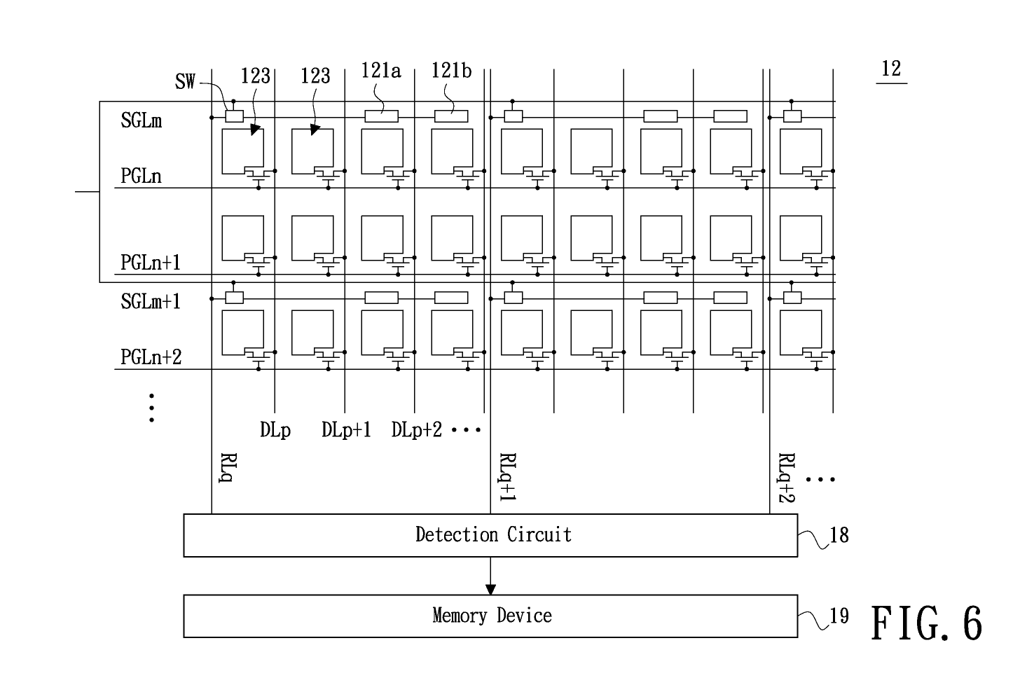

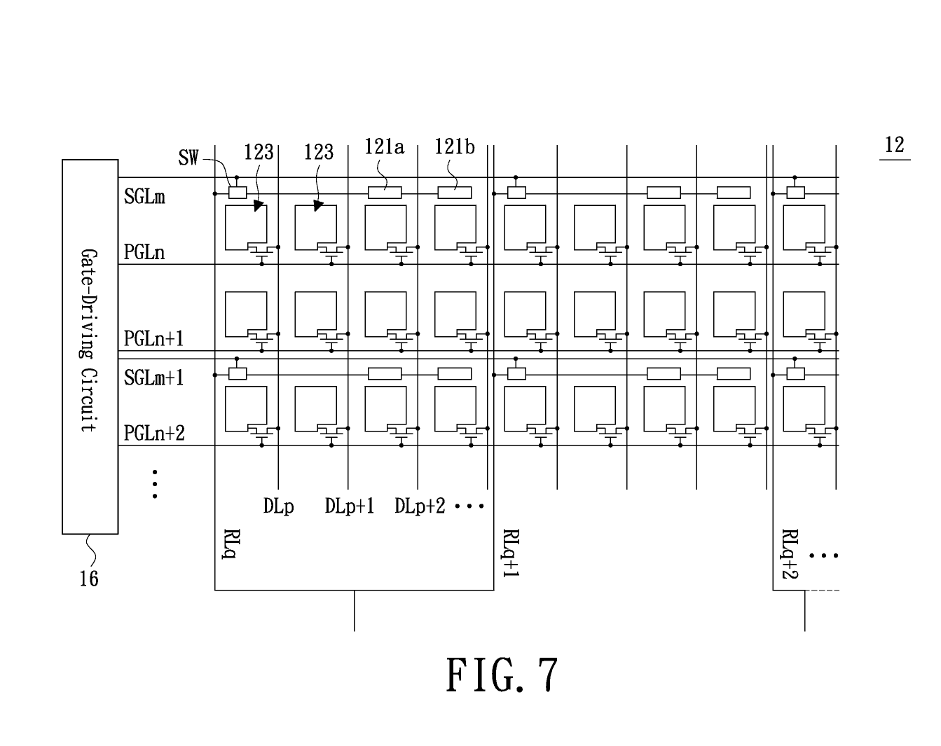

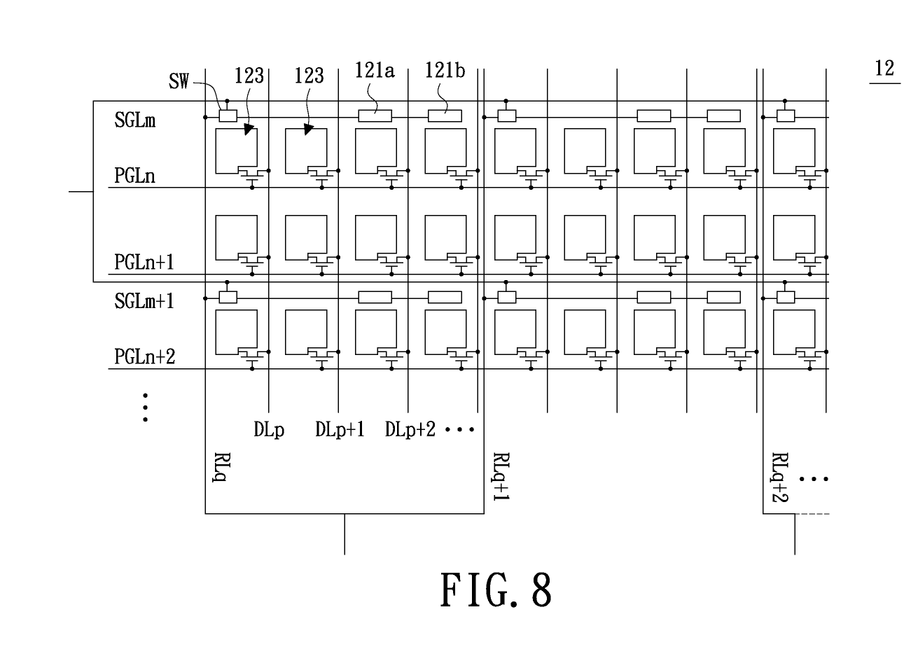

Furthermore, the sensor gate lines SGLm, SGLm+1 of the exemplary embodiment of the present invention are not limited to one-to-one correspond to the signal-channels of the gate-driving circuit 16. Alternatively, the many adjacent sensor gate lines may be electrically coupled to a single signal-channel. Similarly, the readout lines RLq, RLq+1, RLq+2 are not limited to one-to-one correspond to the signal-channels of the detection circuit 18. Alternatively, the many adjacent readout lines are electrically coupled to a single signal-channel. For example, as shown in FIG. 6, the adjacent two sensor gate lines SGLm, SGLm+1 are electrically coupled with each other to be electrically coupled to a single signal-channel of the gate-driving circuit 16. Alternatively, as shown in FIG. 7, the adjacent two readout lines RLq, RLq+1 are electrically coupled with each other to be electrically coupled to a single signal-channel of the detection circuit 18. Herein, the detection circuit 18 regards the signals transmitted by the readout lines RLq, RLq+1 as a same data. Alternatively, as shown in FIG. 8, the adjacent two sensor gate lines SGLm, SGLm+1 are electrically coupled with each other to be electrically coupled to a single signal-channel of the gate-driving circuit 16, and the adjacent two readout lines RLq, RLq+1 are electrically coupled with each other to be electrically coupled to a single signal-channel of the detection circuit 18.

In addition, since the LCD apparatus 100 of the exemplary embodiment of the present invention employs the design of separating the sensor gate lines SGLm, SGLm+1 from the pixel gate lines PGLn, PGLn+1, PGLn+2, each of the sensor gate lines SGLm, SGLm+1 and each of the pixel gate lines PGLn, PGLn+1, PGLn+2 have a same enable time during controlling the LCD apparatus 100. It can be performed by following methods to obtain the same enable time. For example, (1) a method is enabling one of the sensor gate lines simultaneously when enabling each of the pixel gate lines. Alternatively, (2) another method is enabling the sensor gate line SGLm simultaneously when enabling the pixel gate line PGLn, next turning off all of the sensor gate lines simultaneously when enabling the pixel gate line PGLn+1, and enabling the sensor gate line SGLm+1 simultaneously when enabling the pixel gate line PGLn+2, and so on.

Furthermore, when the above many (such as two) adjacent sensor gate lines are electrically coupled to a single signal-channel of the gate-driving circuit 16, the gate-driving circuit 16 will enable the many adjacent sensor gate lines electrically coupled with each other simultaneously. Of course, the method of enabling the many sensor gate lines simultaneously can be similarly adapted for the many sensor gate lines electrically coupled to the different channels of the gate-driving circuit 16 by altering the gate-driving circuit 16. Similarly, when the above many (such as two) adjacent readout lines is electrically coupled to a single signal-channel of the detection circuit 18, the detection circuit 18 will receive the sensor signals transmitted by the many readout lines electrically coupled with each other simultaneously. Of course, the method of receiving the sensor signals transmitted by the many readout lines simultaneously is similarly adapted for the many readout lines electrically coupled the different signal-channels of the detection circuit 18 by altering the detection circuit 18.

The exemplary embodiment of the present invention employs unique circuit constructions of the LCD panel and the LCD apparatus, such as the design of separating the pixel gate lines from the sensor gate lines, the special arrangement of the sensor pads, the designs of electrically coupling the many readout lines with each other, and/or electrically coupling the many sensor gate lines with each other, to obtain dense effective sensing areas for achieving a high touch detection capability with low cost.

In addition, one skilled in the art also can appropriately alter the LCD panel, the LCD apparatus and the control method of the above exemplary embodiment of the present invention, such as appropriately altering the arrangement of the sensor pads on the TFT array substrate, the arrangement of the sensor gate lines, the arrangement of the readout lines, and/or driving the pixel gate lines and the sensor gate lines by different driving circuits, etc.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A liquid crystal display (LCD) panel, comprising:
a first substrate, comprising:
a first pixel;
a first sensor pad arranged adjacent to the first pixel;
a first switch electrically coupled to the first sensor pad;
a first pixel gate line electrically coupled to the first pixel;
a first sensor gate line electrically coupled to the first switch; and
a first readout line; and
a second substrate, comprising:
a first sensing device protruding from the second substrate; and
a conducting layer covering on the first sensing device and electrically coupled to a predetermined power,
wherein the first sensing device is opposite to the first sensor pad when assembling the second substrate with the first substrate, the conducting layer covering on the first sensing device contacts with the first sensor pad when pressing the second substrate, and the first sensor gate line controls on/off state of the first switch to determine whether the first sensor pad is electrically conducted with the first readout line.

2. The LCD panel as claimed in claim 1, wherein the first substrate further comprises:
a second pixel; and
a second sensor pad arranged adjacent to the second pixel,
wherein the first sensor gate line controls the on/off state of the first switch to determine whether the second sensor pad is electrically conducted with the first readout line.

3. The LCD panel as claimed in claim 2, wherein the first substrate further comprises:
a second readout line; and
a second switch electrically coupled to the first sensor gate line, the first sensor gate line controlling on/off state of the second switch,
wherein the second readout line is electrically coupled to the first readout line.

4. The LCD panel as claimed in claim 3, wherein the first substrate further comprises:
a third pixel;
a third sensor pad arranged adjacent to the third pixel;
a third switch electrically coupled between the third sensor pad and the second readout line;
a second pixel gate line electrically coupled to the third pixel; and
a second sensor gate line electrically coupled to the third switch to control on/off state of the third switch,
wherein the second sensor gate line is electrically coupled to the first sensor gate line.

5. The LCD panel as claimed in claim 2, wherein the first substrate further comprises:
a second readout line;
a third pixel;
a third sensor pad arranged adjacent to the third pixel;
a third switch electrically between the third sensor pad and the second readout line;
a second pixel gate line electrically coupled to the third pixel; and
a second sensor gate line electrically coupled to the third switch to control on/off state of the third switch,
wherein the second sensor gate line is electrically coupled to the first sensor gate line.

6. A LCD apparatus, comprising:
a LCD panel, comprising:
a first substrate, comprising:
a first pixel;
a first readout line;
a first sensor pad arranged adjacent to the first pixel;
a first switch electrically coupled between the first sensor pad and the first readout line;
a first pixel gate line electrically coupled to the first pixel; and
a first sensor gate line electrically coupled to the first switch to control on/off state of the first switch; and
a second substrate, comprising:
a first sensing device protruding from the second substrate; and
a conducting layer covering on the first sensing device and electrically coupled to a predetermined power; and
a detection circuit electrically coupled to the first readout line to detect signals of the first readout line,
wherein the first sensing device is opposite to the first sensor pad when assembling the second substrate with the first substrate, and the conducting layer covering on the first sensing device contacts with the first sensor pad when pressing the second substrate.

7. The LCD apparatus as claimed in claim 6, wherein the first substrate further comprises:
a second pixel; and
a second sensor pad arranged adjacent to the second pixel,
wherein the first sensor gate line controls on/off state of the first switch to determine whether the second sensor pad is electrically conducted with the first readout line.

8. The LCD apparatus as claimed in claim 7, wherein the first substrate further comprises:
a second readout line; and
a second switch electrically coupled to the first sensor gate line, the first sensor gate line controlling on/off state of the second switch,
wherein the detection circuit regards signals transmitted by the first readout line and the second readout line as a same data.

9. The LCD apparatus as claimed in claim 8, wherein the first substrate further comprises:
a third pixel;
a third sensor pad arranged adjacent to the third pixel;
a third switch electrically coupled between the third sensor pad and the second readout line;
a second pixel gate line electrically coupled to the third pixel; and
a second sensor gate line electrically coupled to the third switch to control on/off state of the third switch,
wherein the second sensor gate line is electrically coupled to the first sensor gate line.

10. The LCD apparatus as claimed in claim 7, wherein the first substrate further comprises:
a second readout line;
a third pixel;
a third sensor pad arranged adjacent to the third pixel;
a third switch electrically coupled between the third sensor pad and the second readout line;
a second pixel gate line electrically coupled to the third pixel; and
a second sensor gate line electrically coupled to the third switch to control on/off state of the third switch,
wherein the second sensor gate line is electrically coupled to the first sensor gate line.

11. A LCD apparatus, comprising:
a plurality of first pixels;
a plurality of sensor pads, each being arranged adjacent to a corresponding one of the first pixels respectively, the sensor pads generate different signals according to whether corresponding locations of the LCD apparatus are pressed;
a plurality of readout lines;
a plurality of switches, each being arranged between the sensor pads and a corresponding one of the readout lines respectively;
a plurality of pixel gate lines electrically coupled to the first pixels to drive the first pixels;
a plurality of sensor gate lines, each being coupled to the corresponding switches to control on/off states of the corresponding switches; and
a gate-driving circuit for driving the pixel gate lines and the sensor gate lines,
wherein at least two of the readout lines are electrically coupled with each other or at least two of the sensor gate lines are electrically coupled with each other.

12. The LCD apparatus as claimed in claim 11, wherein the at least two of the readout lines are electrically coupled with each other and at least two of the sensor gate lines are electrically coupled with each other.

13. The LCD apparatus as claimed in claim 11, further comprising:
a detection circuit electrically coupled to the readout lines to receive signals transmitted by the readout lines and convert the received signals to be a pressed data; and
a memory device electrically coupled to the detection circuit to store the pressed data.

14. The LCD apparatus as claimed in claim 11, wherein each of the sensor pads is arranged at an opaque area of a corresponding one of the first pixels.

15. The LCD apparatus as claimed in claim 11, wherein each of the first pixels is surrounded by many of the second pixels respectively, and the second pixels are other pixels of the LCD apparatus except for the first pixels.

16. A control method adapted for the LCD apparatus as claimed in claim 11, and the control method comprising:
making each of the sensor gate lines and each of the pixel gate lines have a same enable time.

17. The control method as claimed in claim 16, further comprising:
enabling at least two of the sensor gate lines simultaneously.

18. The control method as claimed in claim 17, further comprising:
receiving signals transmitted by at least two of the readout lines simultaneously.

19. A control method adapted for a LCD apparatus, the LCD apparatus comprising a plurality of pixels, a plurality of sensor pads, a plurality of pixel gate lines and a plurality of sensor gate lines, the pixel gate lines being configured for driving the pixels, the sensor gate lines being configured for driving the sensor pads, the sensor gate lines being not electrically coupled to the pixel gate lines and an amount of the sensor gate lines being less than that of the pixel gate lines, and the control method comprising:
making each of the sensor gate lines and each of the pixel gate lines have a same enable time; and
enabling at least one of the sensor gate lines simultaneously when enabling each of the pixel gate lines.

20. The control method as claimed in claim 19, further comprising:
enabling at least two of the sensor gate lines simultaneously.

21. The control method as claimed in claim 19, wherein the LCD apparatus further comprises a plurality of readout lines and a plurality of switches, each of the switches is arranged between the sensor pads and a corresponding one of the readout lines, and the control method further comprises:
receiving signals transmitted by at least two of the readout lines simultaneously
